(19) United States
(12) Patent Application Publication
(10) Pub. No.: US 2013/0268423 A1
(43) Pub. Date: Oct. 10, 2013

(54) COPY TRADING SYSTEM AND METHOD

(71) Applicant: PENNALUNA & COMPANY INC., Coeur d'Alene, ID (US)

(72) Inventor: Michael Harland Giles, New York, NY (US)

(73) Assignee: Pennaluna & Company Inc., Coeur d'Alene, ID (US)

(21) Appl. No.: 13/860,176

(22) Filed: Apr. 10, 2013

Related U.S. Application Data
(60) Provisional application No. 61/622,402, filed on Apr. 10, 2012.

(51) Int. Cl. G06Q 40/04

(52) U.S. Cl. CPC G06Q 40/04
USPC 705/37

(57) ABSTRACT

A system and method are disclosed that include, in one or more implementations, receiving, with one or more processors from a computing device associated with a broker/dealer, electronic transaction information representing a first transaction executed by a first user. At least one other user is identified to receive a notification of a transaction associated with the first user. A notification that represents the first transaction is transmitted to at least one computing device respectively associated with at least one other user, and an instruction is received that represents an order to execute a second transaction on behalf of the at least one other user. The second transaction copies the first transaction, and the one or more processors generates and transmits an instruction to execute the second transaction.

### CROSS-REFERENCE TO RELATED APPLICATION

The present application claims the benefit of U.S. patent application Ser. No. 61/622,402, filed Apr. 10, 2012, which is hereby incorporated by reference in its entirety.

### BACKGROUND

### Field

The present application relates, generally, to communications and, more particularly, to electronic trading technology.

### SUMMARY

A system and method are disclosed that include, in one or more implementations, receiving, with one or more processors from a computing device associated with a broker/dealer, electronic transaction information representing a first transaction executed by a first user. At least one other user is identified to receive a notification of a transaction associated with the first user. A notification that represents the first transaction is transmitted to at least one computing device respectively associated with at least one other user, and an instruction is received that represents an order to execute a second transaction on behalf of the at least one other user. The second transaction copies the first transaction, and the one or more processors generates and transmits an instruction to execute the second transaction.

In accordance with the teachings herein, a plurality of parties, such as a proprietor of the present application and a broker/dealer, may be a single party.

### BRIEF DESCRIPTION OF THE DRAWING(S)

For the purpose of illustrating the application, there is shown in the drawings a form, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement for receiving, processing and outputting content over a communication network in accordance with an implementation;

FIG. 2 illustrates example functional elements of information processor and/or user workstation, in accordance with an implementation;

FIGS. 3-11 illustrate example display screens provided to one or more registered users in accordance with an embodiment of the present application; and

FIGS. 12 and 13 are flowcharts illustrating example steps associated with one or more implementations.

### DESCRIPTION OF EMBODIMENTS

The present application provides a system and method for tracking various activity, such as associated with electronic trading, and for notifying users of the activity. Notified users may elect to perform the same tracked activity, for example, in order to take advantage of an opportunity evidenced by the tracked activity. In an embodiment, users register with an information processor, which may be a server computer or other computing device, and registered users connect to one or more on-line broker/dealers via the information processor. One or more registered users may “follow” a particular person's activity, or representative's activity (e.g., including via a computerized or automated process), and are notified when some action is taken. Thereafter, the one or more registered users may elect to mimic the same action, such as to take advantage of an opportunity.

In an embodiment, information associated with a person's activity is substantially automatically received by the information processor(s), and the information processor(s) transmit related information to the person's followers.

In accordance with an embodiment, registered users may define or select rules, for example, for choosing the type of product allowed to be replicated, for selecting either fixed or percentage based amount, for selecting the exact dollar amount, or for selecting a precise percentage amount. Moreover, rules may be defined for enabling the information processor (or associated computing device) to perform one or more steps substantially automatically in response to information that is received and that represents some activity taken by a person being followed. Rules may be added, changed or deleted, as appropriate.

It is recognized by the inventor that users may want to be followed. Some users knowingly and voluntarily share information about their trading activities as a courtesy to friends or family, or simply out of generosity. In an embodiment, users may receive incentives, such as payment, for allowing others to follow them. In an embodiment, payment is generated as a function of trading activity that occurs directly from following a user. For example, a user who is being followed executes a trade. Three other users who are following the user execute the same trade in accordance with the teachings herein. Revenue may be generated by each of the respective trades of the three following users.

In an embodiment, revenue is generated by fees paid by online broker/dealers and/or other third parties, for activity generated as a function of the present application. For example, an order to be executed is received by an online broker/dealer, and the broker/dealer pays for receiving the order. Other revenue may be generated by advertising links embedded in trading activity units.

Referring now to the reference figures, in which like reference numerals refer to like elements, FIG. 1 shows an example hardware arrangement for receiving, processing and outputting content over a data/communication network, such as the Internet. As shown in FIG. 1, an information processor 102, optionally functioning as an internet web server, provides electronic content 103 to a user workstation 104 that communicates with information processor 102 via communication network 106. Alternatively, content 103 is provided to user workstation 104 without the use of communication network 106. Content 103 includes, for example, text, graphics, pictorial, audio and video material. The user workstation 104 may employ software that enables a communication session to be established between the user workstation 104 and information processor 102. Information processor 102 employs software enabling a communication session, for example an HTTP session, to be established between the user workstation 104 and the information processor 102.

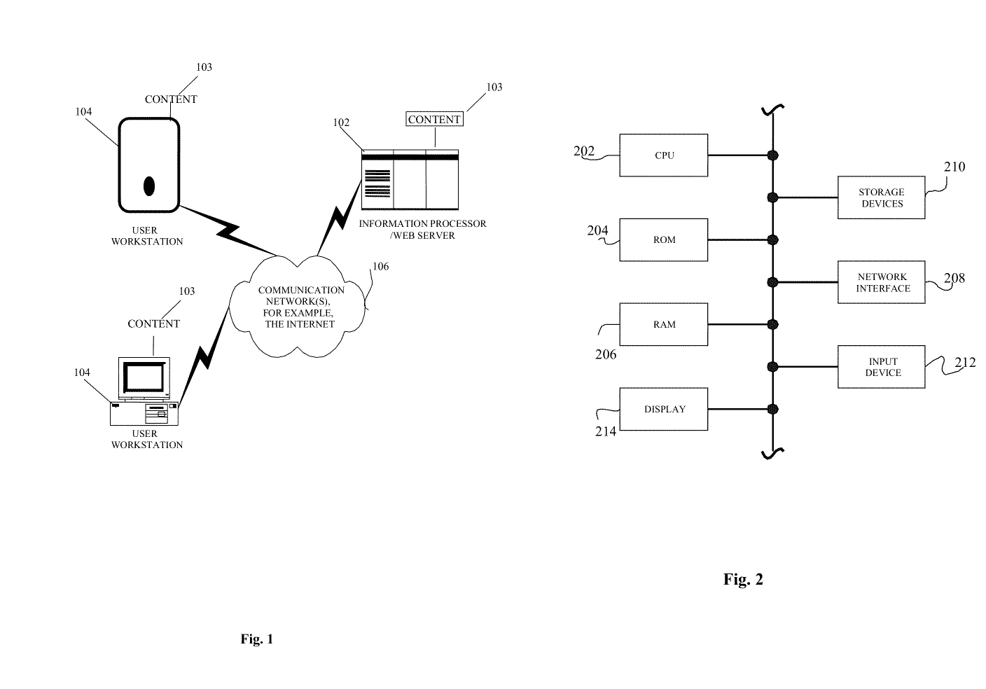

FIG. 2 illustrates example functional elements of information processor 102 and/or user workstation 104, and may include one or more of: one or more central processing units (CPU) 202 used to execute software code and control the operation of information processor 102 and/or user workstation 204, read-only memory (ROM) 204, random access memory (RAM) 206, one or more network interfaces 208 to transmit and receive data to and from other computing devices across a communication network, processor-readable storage medium 210 such as a hard disk drive, floppy disk drive, tape drive, CD ROM or DVD for storing program code, databases and application data, one or more input devices 212 such as a keyboard, mouse, track ball, virtual keyboard, touchscreen, microphone and the like, and a display 214.

The various components of information processor 102 and/or user workstation 104 need not be physically contained within the same chassis or even located in a single location. For example, storage device 210 may be located at a site which is remote from the remaining elements of production user workstation 104, and may even be connected to CPU 202 across communication network 106 via network interface 208. In an example embodiment, information processor 102 and/or user workstation 104 includes a memory equipped with sufficient storage to provide the necessary databases, forums, and other community services as well as acting as a web server for communicating hypertext markup language (HTML), Java applets, Active-X control programs or the like to information processor 102 and/or user workstation 104. Information processor 102 and/or user workstation 104 is arranged with components, for example, those shown in FIG. 2, suitable for the expected operating environment of information processor 102 and/or user workstation 104. The CPU(s) 202, network interface(s) 208 and memory and storage 210 are selected to ensure that capacities are arranged to accommodate expected demand. The nature of the present invention is such that one skilled in the art of writing computer executable code (i.e., software) can implement the described functions using one or more of a combination of popular computer programming languages and developing environments including, but not limited to C, C++, Visual Basic, JAVA, HTML, XML, ACTIVE SERVER PAGES, FLASH, PHP, JSON, JAVA server pages, servlets, and a plurality web site development applications.

It is contemplated herein that any suitable operating system can be used on information processor 102 and/or user workstation 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, MAC OS, UNIX, LINUX, PALM OS POCKET PC, IOS, DROID, BLACKBERRY, TIZEN, any other suitable operating system.

As used herein, the term, “module,” refers, generally, to one or more discrete components that contribute to the effectiveness of the systems and methods described herein. Modules can include software elements, including but not limited to functions, algorithms, classes and the like. Modules also include hardware elements, substantially as described below. Modules can operate independently or, alternatively, depend upon one or more other modules in order to function.

As used herein, references to displaying data on information processor 102 and user workstation 104 regard the process of communicating data across communication network 106 and processing the data such that the data is viewed on a display 216, for example, by using a web browser and the like. As is known with web browsing software, the display 216 on user workstation 104 presents sites such that a user can proceed from site to site within the system by selecting a desired link.

In an embodiment, one or more application programming interfaces or other similar web services (collectively, API's), are used by the information processor to integrate the information processor with one or more broker/dealers to effect trades or other activity. Registered users may transmit an instruction to information processor to take some action (such as to make a trade), and information processor interfaces with a respective broker/dealer via an API to effect the action. In an embodiment, instructions are transmitted automatically in accordance with the registered users' predefined rules. Alternatively, one or more prompts are transmitted to users who reply thereto to instruct information processor to take some action. Moreover, some combination of automatic/manual activity may be supported.

In an embodiment, a user interface is provided for registered users to submit profile-related information, and information representing particular people the users wish to follow and rules associated with activity. The interface provides a convenient and intuitive way for registered users to define one or more parameters associated with trading or other forms of activity, as well as to transmit instructions to the information processor for conducting a trade or other activity.

Thus, unlike known and conventional ways of copying an investor's trade history, such as via verbal or written message, the present application provides for instantaneous and automatically copying via a centrally managed set of rules and activities. In an embodiment, “1-click” copy trading is provided that allows a registered user with a linked broker/dealer account, such as E*TRADE, to copy the trade of another user by clicking a single button, such as on a mobile computing device (e.g., a smartphone) or other computing device. This provides a significant improvement over known methods, such as by watching what a particular trader had bought or sold, and, thereafter, manually logging in to a broker/dealer trading account and enter the trade. The savings in time provided by the present application may often result in buying or selling at a particular price that is significantly better than a price at even just a few moments later in time.

Accordingly, the present application provides a fast and efficient mechanism for ensuring the best execution price in trading. Referred to generally, herein, as “copy trading,” the present application allows a user to execute his/her trade with the click of a button and in only a few seconds. Moreover, information regarding a followed person's (e.g., a registered user's) activity is provided substantially in real-time, which further improves the ability for followers to conduct one or more trades (or other activity) immediately, and enjoy the benefits of the market or other environment at a particular time.

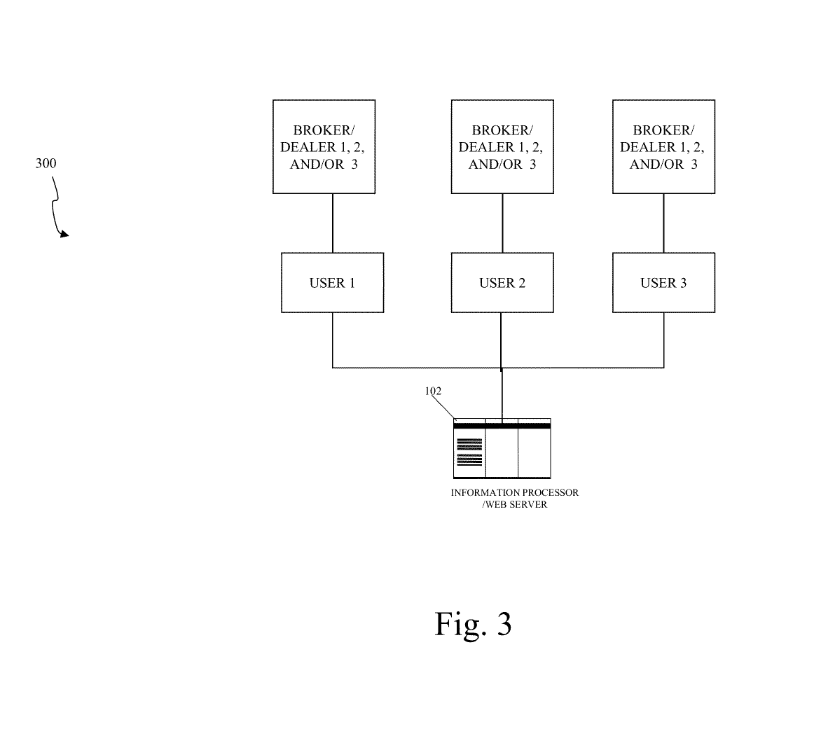

The present application is now further described with reference to example display screens illustrated in FIGS. 3-10. As used herein, the trademark, “ROBOINVEST” is shown and used, generally, refers to an embodiment of the present application that includes at least some of the features shown and described herein. Use of ROBOINVEST is not meant to limit or otherwise restrict the scope of protection afforded by the present application.

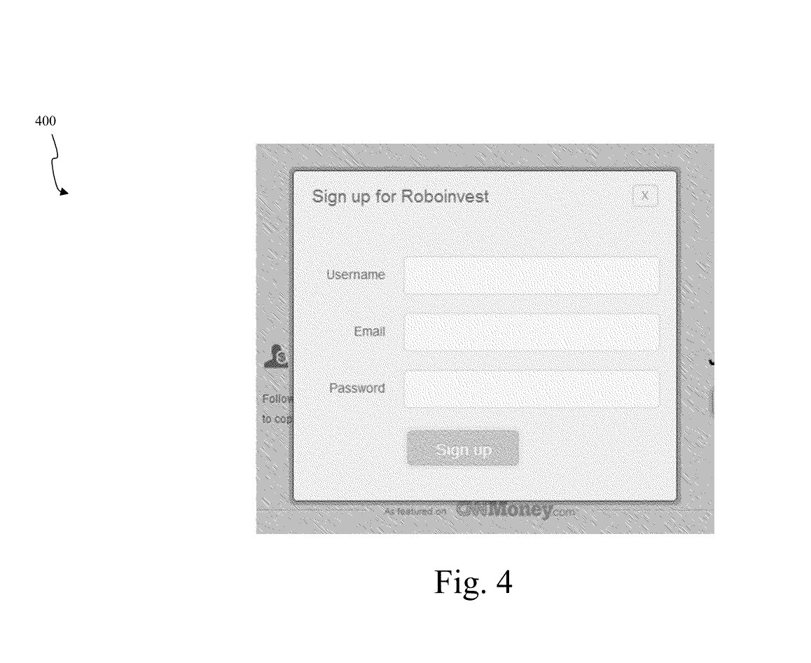

FIG. 3 is a block diagram illustrating an example implementation of the present application. As shown in FIG. 3, three users (User (1), User (2) and User (3)) have registered with at least one information processor 102 (e.g., server). For example, each of the users provided profile information including at least user name, email address and password to “sign up” with information processor 102. An example profile setup display screen 400 is shown in FIG. 4. In the example shown in FIG. 4, Username represents a profile name chosen by the new user, Email is the email address of the new user and Password is the password chosen by the new user. As set forth herein for exemplary purposes, Users (1), (2) and/or (3) may be being followed, or may be followers. Moreover, and as shown in FIG. 3, each of the Users 1, 2 and 3 are respectively coupled (e.g., operatively coupled and/or communicatively coupled) to Broker/Dealer 1, 2 and/or 3 for effecting one or more trades.

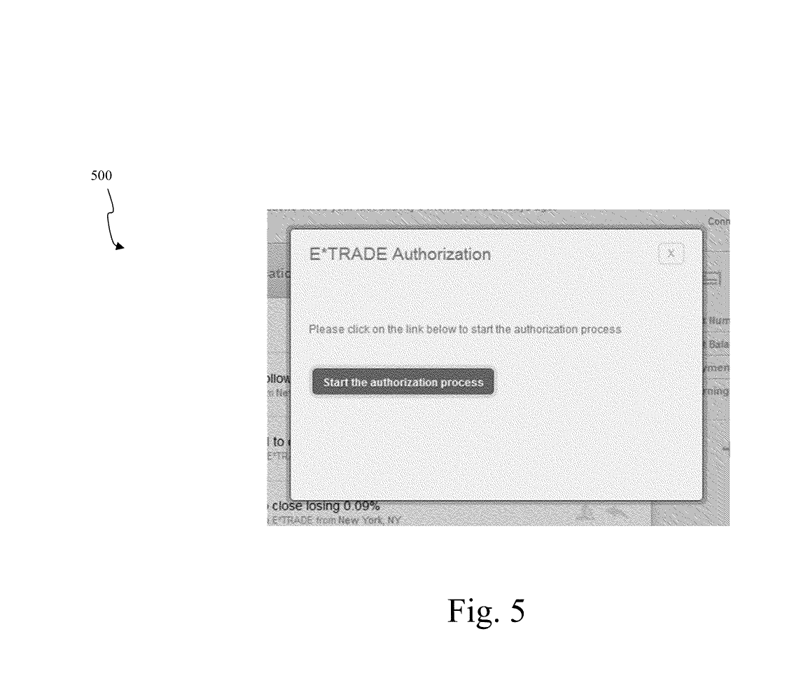

FIG. 5 illustrates an example “Start the authorization process” display screen 500 that is usable for a user to provide authorization for functionality shown and described herein. For example, a user enters valid online trading account log-in credentials to authorize a link between an online broker/dealer API (described herein) and an application (e.g., as provided via the information processor).

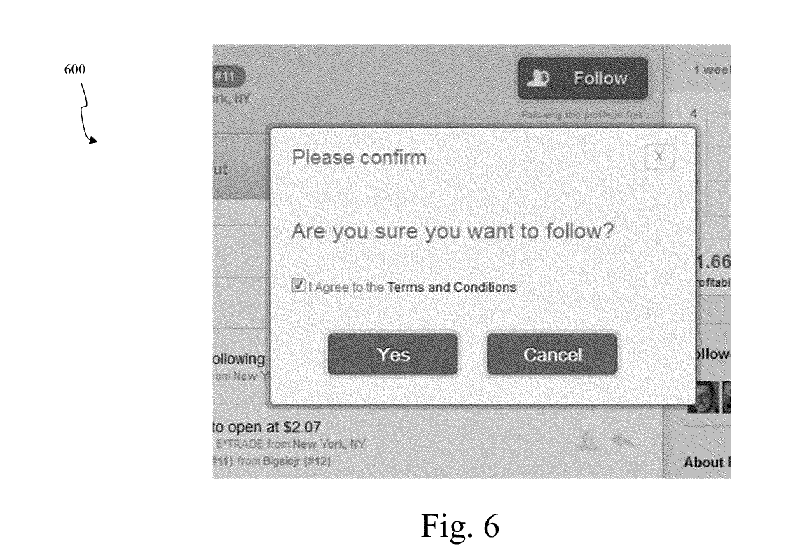

FIG. 6 illustrates an example confirmation display screen 600 for a registered user to confirm that (s)he wants to follow, as set forth herein, a particular person. In the example shown in FIG. 6, prior to confirming that a user is going to follow someone's trading activity, the user submits an instruction that the user accepts terms and conditions associated with the teachings herein. Such terms and conditions may relate, for example, to privacy conditions associated with other users. Once the user has registered, agrees to the terms and conditions (e.g., by checking a checkbox graphical screen control), and submits confirmation that the user wants to follow someone (e.g., by pressing a windowed button), the user may use features associated with the present application.

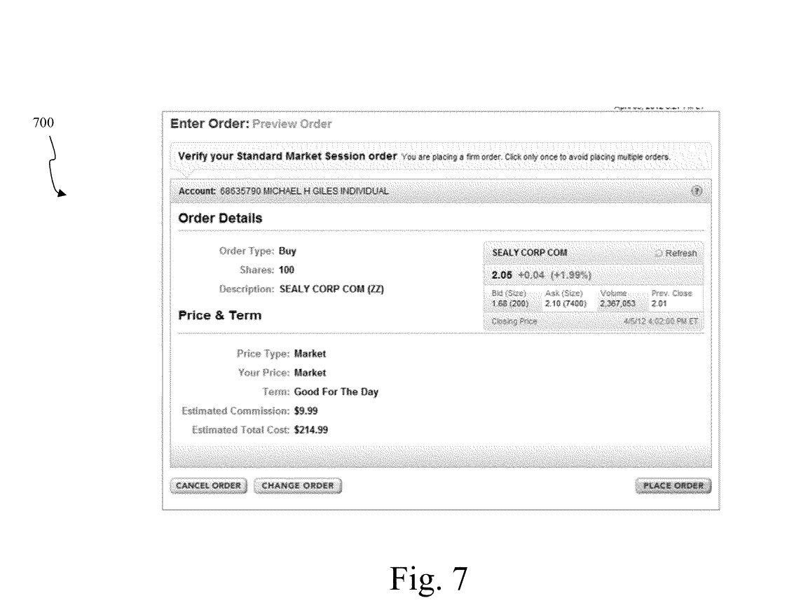

FIG. 7 illustrates an example Preview Order display screen 700 that is provided by a broker/dealer for a user to review details in connection with an original order in accordance with an embodiment.

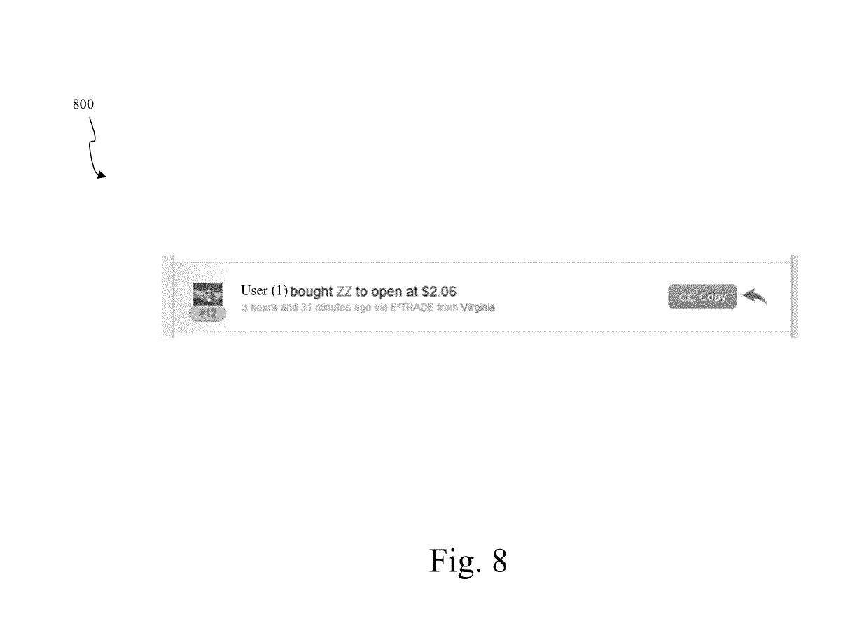

FIG. 8 illustrates an example display screen 800 illustrating an executed trade in connection with an online trading account of a user's online broker/dealer. In the example shown in FIG. 8, User (1) is the person being followed. As shown in FIG. 8, the terms, “bought” and “open” refer, generally, to buying a long position. Moreover, the symbol “ZZ” represents the bought long position. The copy button on the right side of the display screen enables the user to facilitate the 1-click copy trading function to replicate a bought position.

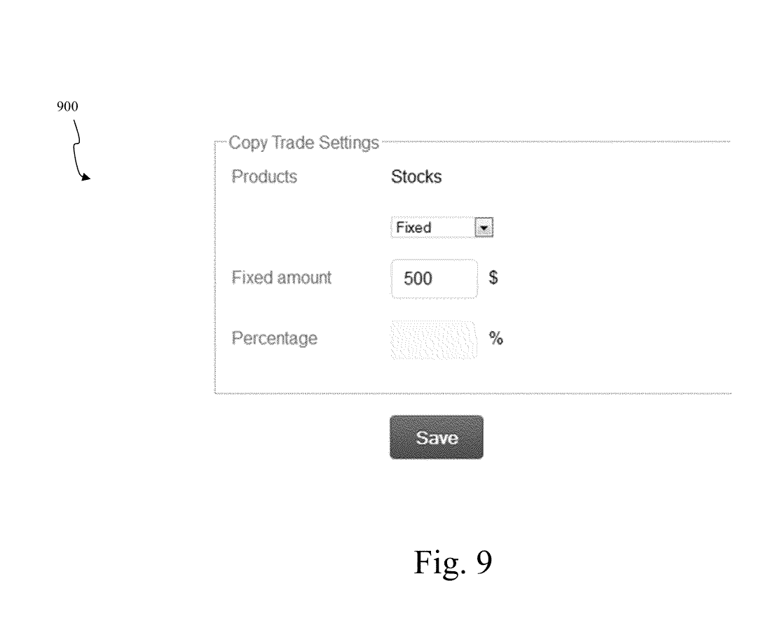

FIG. 9 illustrates example display screen 900 showing parameter settings for a user. As shown in FIG. 9, “Product” represents the type of financial product User (2) is authorizing to be copied (based on a followed person's activity). The values “Fixed amount” and “Percentage” represent quantity and percent trade options that User (2) wants trade (2) to be calculated and replicated for execution. In case of a fixed amount, when User (2) clicks the copy button of trade (1), the information processor calculates the number of units that are needed to be purchased, based on the execution price of trade (1). Alternatively, in case of a percentage amount, when User (2) clicks the copy button of trade (1), the information processor calculates the number of units that are needed to be purchased based on the price from trade (1).

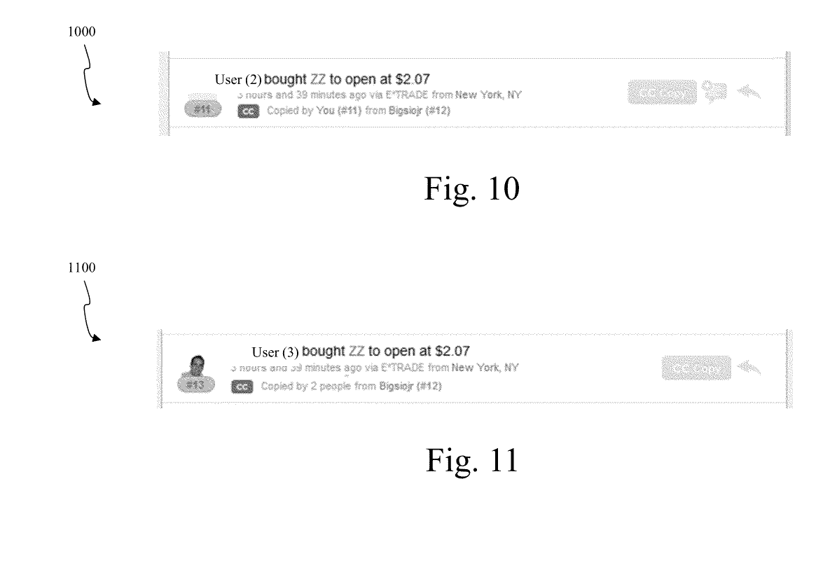

FIGS. 10 and 11 are example purchase statements 1000 and 1100, respectively, provided to a User (2) who has copied User (1) (FIG. 8) purchase of “ZZ” to open at $2.07. Another follower, User (3), similarly copied User (1) purchase of “ZZ” to open at $2.07 (FIG. 11). In one or more implementations of the present application, a follower (e.g., User (2)) may select one or more options to define a percentage value that represents a percentage of transactions (e.g., value of transactions and/or number of transactions) of a leader (e.g., User (1)) that the follower wants to emulate.

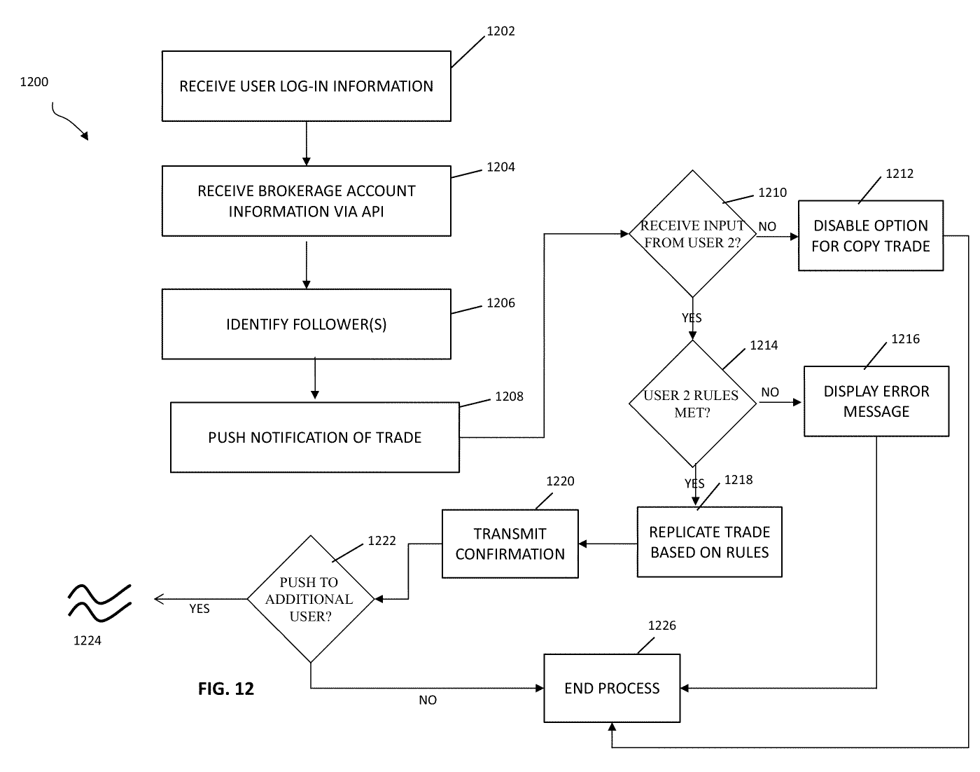

An example embodiment of the present application is now further described with reference to the process 1200 illustrated in the flowchart shown in FIG. 12.

At step 1202, user login information is received. As noted above with reference to FIG. 3, User (1), User (2) and User (3) register to provide trading accounts, which establish one or more links between an online broker broker/dealer and the user's respective profile in connection with and/or managed by information processor 102 (FIG. 2). User login information may be received at various times, such as when a user launches a mobile software application distributed in accordance with information processor 102, or when a user logs into a web site hosted by or otherwise associated with information processor 102. Moreover, a connection may be established by information processor 102, including by developing an integration between a software application and an online broker/dealer application programming interface.

At step 1204, information is received via an API regarding on-line investment activity, such as that User (1) successfully executed a valid trade (1) to open a position through User's (1) online trading account at a respective online broker/dealer (FIG. 4). Information regarding the trade may be substantially automatically transmitted to information processor 102 from the online broker/dealer, such as by push notification (as known in the art), and a database record may, thereafter, be made and displayed to User (2) by push notification. Alternatively, one or more processes may execute on information processor 102 to listen or otherwise monitor for activity, such as associated with an online trade. For example, information may be provided on a web site that is associated with information processor 102, via an application interface. The result may be an activity unit established via one or more background connections between online broker/dealer(s) and information processor 102 for User (1), User (2) and User (3). Information is reference via the users' profile(s) referenced by information processor 102 for copy-trade activity (FIG. 5). Accordingly, at step 1206, follower(s) of User (1) are identified as directed to receive information relating to the trade executed by User (1), and a notification is pushed there to (1208).

Thereafter, a determination is made whether any information is received from one of the follower(s) (e.g., User (2)), such as an instruction to copy the trade (1210). If not, such as after a predetermined amount of time, then the process branches to step 1212 and one or more actions may be taken, such as to disable an option for User (2) to copy the trade. For example, a graphical screen control (e.g., a button) may turn to the color gray and become non-functional. Moreover, in one or more implementations, if User (2) does not select an option, such as to copy the trade, then a corresponding copy button for an additional trade (3) may further not be displayed to User (2).

If the determination at step 1210 is that input is received from User (2), then the process branches to 1214 and a determination is made whether the input that is received is in compliance with one or more rules associated with User (2). Pre-existing rules may include, but are not limited to: User (2) choosing the type of product allowed to be replicated; User (2) choosing either fixed or percentage based amount; in case of a fixed based amount, User (2) chooses the exact dollar amount; and if percentage based amount, User (2) chooses the exact percentage amount. With regard to FIG. 12, for example, User (2) selects the “copy” button on the web or mobile application interface associated with the activity unit that displays trade (1), to issue an instruction to copy the open position. If User (2)'s rules are not met, then the process branches to 1216 and an error message is displayed.

Continuing with reference to the flow chart shown in FIG. 12, if the determination in step 1214 is that the rules are met then, based on pre-existing rules set by User (2) (FIG. 6), User (1)'s trade (1) is replicated through User (2) online trading account in accordance to their rules by creating and sending a new market order through a programmatic background connection between information processor 102 (and/or user workstation 104) and the online broker/dealer for preview (1218). The online broker/dealer may respond with a unique order ID, which may be sent back to the online broker/dealer with the final order message for execution. Thereafter, the process continues to step 1220 and a confirmation message may be sent from the online broker/dealer containing the final details of the trade, which may then be used in generating the activity unit of trade (2).

In an alternative implementation, User (1)'s trade (1) (or a percentage thereof) is replicated substantially automatically and via a “1-click” process. In this implementation, a preview step and corresponding confirmation process may be omitted to ensure timely trading that operates virtually instantaneously upon reception of an instruction (via “1-click”) from a user computing device. Thus, the present application supports various operation modes in accordance with one or more predefined rules defined by a user and that may vary in the number of procedural steps.

Continuing with reference to FIG. 12 after step 1220, the process continues to step 1222, and a determination is made whether trade information is to be pushed to an additional user (e.g., User (3)). It may be for example, that User (3) has registered to follow the activity of User (2). In such case, an activity unit associated with the confirmed trade of User (3) is to be pushed to User (3). Alternatively, it may be that User (3) is registered to follow User (1). In such case, the confirmation associated with User (1) is pushed to User (3).

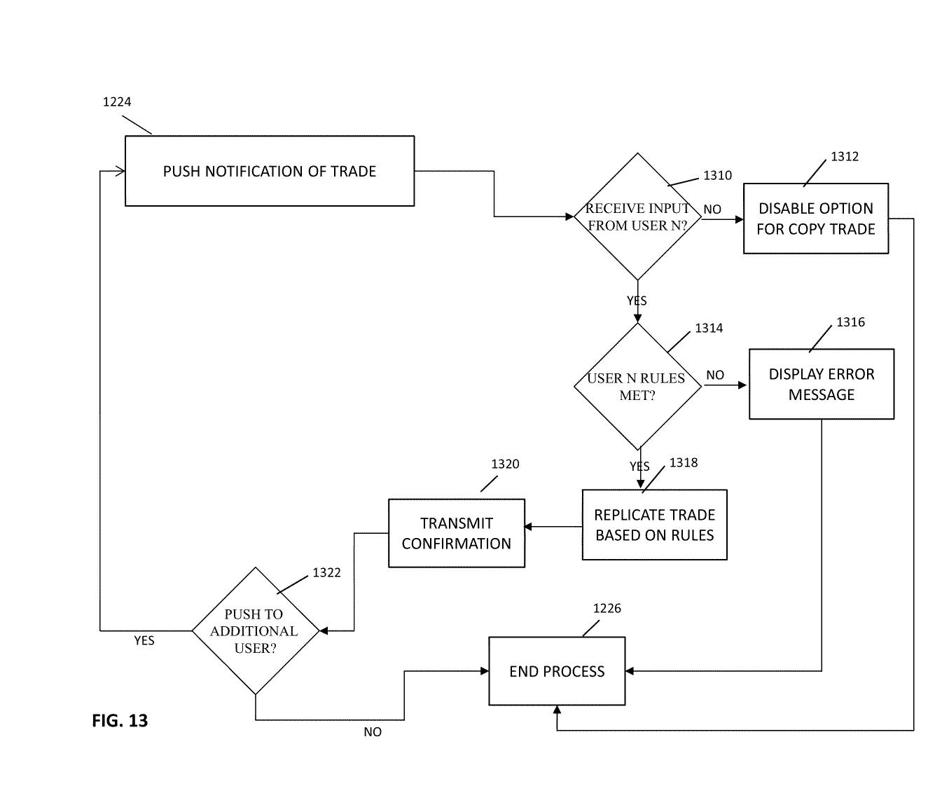

If the determination at step 1222 is that information should be pushed to an additional user, then the process branches to step 1224 (FIG. 13). Otherwise, the process branches to step 1226, and the process ends.

FIG. 13 is a flow chart illustrating example steps associated with pushing activity information to an additional user (represented as user N). At step 1224, notification of a trade is pushed. As noted above notification may represent activity associated with User (2), activity associated with a user following User (1), or activity associated with a user following a user who is following User (1) (etc.).

At step 1310, a determination is made whether input is received from User (N). If the determination at step 1310 is that input is received from User (N), then the process branches to 1314 and a determination is made whether the input that is received is in compliance with one or more rules associated with User (N). If the determination in step 1314 is that the rules are met then, based on pre-existing rules set by User (N) (FIG. 6), User (1)'s (or User (2)'s or other followed user(s)') trade is replicated through User (N) online trading account in accordance to their rules by creating and sending a new market order through a programmatic background connection between information processor 102 (and/or user workstation 104) and the online broker/dealer for preview (1318). Thereafter, the process continues to step 1320 and a confirmation message may be sent from the online broker/dealer containing the final details of the trade, which may then be used in generating the activity unit of trade (N).

Thereafter, the process continues to step 1322, and a determination is made whether trade information is to be pushed to an additional user (e.g., User (4)). If the determination at step 1322 is that information should be pushed to an additional user, then the process branches to step 1224. Otherwise, the process branches to step 1226, and the process ends.

Accordingly, and as illustrated in FIG. 12, upon User (2) clicking a graphical screen control, such as a “ copy” button displayed in associated with an activity unit (e.g., 1000, 1100) of trade (1), a calculation is substantially automatically made for the exact order in compliance with User (2)'s pre-existing rules.

If User (2)'s trade (2) is successfully executed, a new activity unit may be created and pushed to a web site and/or mobile application interface, which displays the trade (2) replicated from User (1) by User (2), annotated with trade (1) successfully executed by User (1) (FIG. 7).

If User (3) has taken the action to follow User (1) and/or User (2), then activity units for trade (1) and trade (2) are created and pushed to the web site and/or mobile application interface and displayed to User (3), annotated with User (2) having copied User (1) (FIG. 8).

If User (1) successfully executes trade (3) to close the trade (1) position in part or whole, User's (1) trade (3) is displayed to User (2) by push notification on the web site and/or and mobile application interface of the activity unit with a copy button.

If User (2) clicks the copy button of the activity unit for trade (3), the identical amount expressed as a percentage is replicated through User (2) online trading account by creating and sending a new market order through a programmatic background connection between information processor 102 and the online broker/dealer for execution.

If User (2)'s trade (4) is successfully executed, a new activity unit may be created and pushed to the web site and/or mobile application interface displaying the trade (4) replicated from User (1) by User (2), annotated with trade (3) successfully executed by User (1).

If User (2) had a pre-existing holding of units for symbol in trade (3), trade (4) will only match to close the part or all of the position opened in trade (2).

Thus, as shown and described herein, the present application provides a convenient and intuitive system and method for enabling users to execute trades by copying others and effectively via a “1-click” interface by information processor 102 programmatically handling the steps in the background for the user. Preferably, information is provided substantially in real-time, which enables users to act quickly to take advantage of opportunities as those opportunities are presented.

Although the present invention is described and shown in relation to particular embodiments thereof, many other variations and modifications and other uses will become apparent to those skilled in the art. Thus, various embodiments and variations are shown and described herein, and it is preferred, therefore, that the present invention be limited not by the specific disclosure herein.

What is claimed is:

1. A computer-implemented method, comprising:
receiving, with one or more processors executing code, from a computing device associated with a broker/dealer, electronic transaction information representing a first transaction executed by a first user;
identifying, with the one or more processors, at least one other user to receive a notification of a transaction associated with the first user;
transmitting, with the one or more processors, a notification representing the first transaction to at least one computing device respectively associated with at least one other user;
receiving, with the one or more processors, an instruction from the at least one user computing device associated with the at least one other user, wherein the instruction represents an order to execute a second transaction on behalf of the at least one other user, wherein the second transaction copies the first transaction;
generating, with the one or more processors, an instruction to execute the second transaction; and
transmitting, with the one or more processors, the instruction to execute the second transaction to at least one computing device associated with a broker/dealer.

2. The method of claim 1, wherein the electronic transaction information is received via an application programming interface or Internet web service.

3. The method of claim 1, wherein the instruction from the at least one user computing device is received via a mobile computing device software application.

4. The method of claim 3, wherein the mobile computing device software application includes a graphical user interface for copying trades.

5. The method of claim 1, further comprising receiving, from at least one user, at least one rule associated with the second transaction.

6. The method of 5, wherein the at least one rule represents at least one of type of product to be replicated, fixed-based or percentage-based amounts, a dollar amount, a percentage amount, and to perform activity without receiving consent.

7. A processor-readable storage medium containing a graphical user interface comprising:
a first graphical element displayable on a display device and for indicating a user identified for conducting a transaction;
a second graphical element displayable on the display device and for indicating an option to take with respect to the transaction,
wherein selection of the second graphical element causes at least one instruction contained with the processor-readable storage medium to executed by at least one processor that causes the processor to transmit to at least one other computing device an instruction that represents an order to execute a second transaction, wherein the second transaction copies the first transaction.

8. A system, comprising:
one or more processor-readable media;
one or more processors operatively coupled to the one or more processor-readable media;
at least one database stored on the one or more processor readable media, the at least one database comprising:
electronic user information relating to a plurality of respective users; and
electronic broker/dealer information relating to a plurality broker/dealers;
the one or more processor readable media having instructions for causing the following steps to be performed by the one or more processors:
receive from a computing device associated with a broker/dealer, electronic transaction information representing a first transaction executed by a first user;
identify at least one other user to receive a notification of a transaction associated with the first user;
transmit a notification representing the first transaction to at least one computing device respectively associated with at least one other user;
receive an instruction from the at least one user computing device associated with the at least one other user, wherein the instruction represents an order to execute a second transaction on behalf of the at least one other user, wherein the second transaction copies the first transaction;
generate an instruction to execute the second transaction; and
transmit the instruction to execute the second transaction to at least one computing device associated with a broker/dealer.

9. The system of claim 8, wherein the electronic transaction information is received via an application programming interface.

10. The system of claim 8, wherein the instruction from the at least one user computing device is received via a mobile computing device software application.

11. The system of claim 10, wherein the mobile computing device software application includes a graphical user interface for copying trades.

12. The system of claim 8, wherein the one or more processor readable media further have instructions for causing the one or more processors to receive at least one rule associated with the second transaction.

13. The system of 12, wherein the at least one rule represents at least one of type of product to be replicated, fixed-based or percentage-based amounts, a dollar amount, a percentage amount, and to perform activity without receiving consent.
